(19) United States
(12) Patent Application Publication
(10) Pub. No.: US 2023/0366238 A1
(43) Pub. Date: Nov. 16, 2023

(54) BLUETOOTH SMART PADLOCK

(71) Applicant: HOLITECH TECHNOLOGY AMERICA, INC., Santa Clara, CA (US)

(72) Inventors: Xiaobing MAO, Santa Clara, CA (US); Songjin YAO, Santa Clara, CA (US); Lun WANG, Santa Clara, CA (US)

(73) Assignee: HOLITECH TECHNOLOGY AMERICA, INC., Santa Clara, CA (US)

(21) Appl. No.: 17/744,313

(22) Filed: May 13, 2022

(51) Int. Cl. E05B 47/00; E05B 67/02; E05B 67/22; G07C 9/00

(52) U.S. Cl. CPC E05B 47/0012; E05B 67/02; E05B 67/22; G07C 9/00309; E05B 2047/0016; E05B 2047/0024; E05B 2047/0058; E05B 2047/0067; G07C 2009/00325

(57) ABSTRACT

Disclosed is a Bluetooth smart padlock, including a lock housing, a lock beam, a lock tab assembly, a power assembly and a sensing switch. The lock housing is provided with a Bluetooth module for establishing a communication with a mobile terminal and a controller electrically connected with the Bluetooth module; the lock beam is partially provided in the lock housing, and provided with a lock tab groove; a lock tab assembly and a power assembly are both provided in the lock housing, wherein the lock tab assembly comprises a lock tab piece, and the power assembly is in transmission connection with the lock tab piece to drive the lock tab piece to extend into or separate from the lock tab groove, to unlock or lock the lock beam; and the sensing switch is provided on the lock housing for controlling the power assembly.

### TECHNICAL FIELD

The present application relates to the technical field of electronic padlock, in particular to a Bluetooth smart padlock.

### BACKGROUND

Electronic padlock has gradually replaced the traditional padlock and becomes a mainstream product of small locks in the market because of its convenient use and wireless manipulation by mobile devices.

However, when unlocking the existing electronic padlock, it often needs to be close to the electronic padlock, the electronic padlock needs to be unlocked through the mobile phone after the mobile phone is connected with the Bluetooth module of the electronic padlock. This unlocking method is cumbersome, which makes it inconvenient to unlock the electronic padlock.

### SUMMARY

The main purpose of the present application is to provide a Bluetooth smart padlock, which aims at improving an unlocking convenience of the Bluetooth smart padlock.

In order to achieve the above purpose, the present application provides a Bluetooth smart padlock, comprising: a lock housing provided with a Bluetooth module for establishing a communication with a mobile terminal and a controller electrically connected with the Bluetooth module; a lock beam partially provided in the lock housing, and provided with a lock tab groove; a lock tab assembly and a power assembly both provided in the lock housing, wherein the lock tab assembly comprises a lock tab piece, and the power assembly is in transmission connection with the lock tab piece to drive the lock tab piece to extend into or separate from the lock tab groove, to unlock or lock the lock beam; and a sensing switch provided on the lock housing for controlling the power assembly through the controller to drive the lock tab assembly to unlock the lock beam after the communication between the Bluetooth module and the mobile terminal is established.

Optionally, the lock tab piece comprises a first lock tab piece and a second lock tab piece, one end of the lock beam is extended to be a long lock beam and another end of the lock beam is extended to be a short lock beam; wherein the short lock beam is provided with a first lock tab groove, and the long lock beam is provided with a second lock tab groove, the first lock tab piece is extended into the first lock tab groove and the second lock tab piece is extended into the second lock tab groove, to make the lock tab assembly lock the lock beam.

Optionally, the first lock tab piece is located above the second lock tab piece.

Optionally, the first lock tab piece comprises a first flat plate part, a first transmission part connected at one end of the first flat plate part and a first lock tab part connected at another end of the first flat plate part; the second lock tab piece comprises a second flat plate part, a second transmission part connected at one end of the second flat plate part and a second lock tab part connected at another end of the second flat plate part; the power assembly comprises a cam located between the first flat plate part and the second flat plate part, and two opposite sides of the cam are abutted against the first transmission part and the second transmission part respectively, the cam is in transmission connection with the first transmission part and the second transmission part, to drive the first lock tab part to extend into or separate from the first lock tab groove and to drive the second lock tab part to extend into or separate from the second lock tab groove.

Optionally, the first lock tab piece is further provided with a first elastic piece at one end of the first transmission part; the second lock tab piece is further provided with a second elastic piece at one end of the second transmission part; the first lock tab piece and the second lock tab piece are mounted in a lock tab mounting frame, and the lock tab mounting frame is provided with a first opening for the first lock tab piece to extend out and a second opening for the second lock tab part to extend out; the first elastic piece is abutted against one end of the lock tab mounting frame away from the first opening, and the second elastic piece is abutted against one end of the lock tab mounting frame away from the second opening.

Optionally, the first lock tab piece further comprises a first limit part, and the second lock tab piece further comprises a second limit part; the lock tab mounting frame is provided with a first stop part and a second stop part; after the first lock tab part is separated from the first lock tab groove and the second lock tab part is separated from the second lock tab groove, the first limit part is abutted against the first stop part, the second limit part is abutted against the second stop part.

Optionally, a cam limit part is provided in the lock tab mounting frame, after a convex part of the cam is abutted against the cam limit part, the first lock tab part is extended into the first lock tab groove and the second lock tab part is extended into the second lock tab groove.

Optionally, the power assembly further comprises a motor mounted on the power mounting frame, a rotating shaft of the motor is in transmission connection with the cam, the power mounting frame is provided with an exit port for the rotating shaft extending out, and a sealing ring is clamped between the rotating shaft and a wall of the exit port.

Optionally, the lock housing is provided with a long lock beam groove receiving the long lock beam and a short lock beam groove receiving the short lock beam, a bottom of the long lock beam groove is provided with a lock beam spring, and the long lock beam is located above the lock beam spring.

Optionally, the long lock beam is provided with a lock beam limit groove, the lock housing is provided with a lock beam limit bolt, and at least part of the lock beam limit bolt is located in the lock beam limit groove.

In a technical solution of the present application, the Bluetooth smart padlock is provided with a sensing switch. After the Bluetooth module establishes a communication with the mobile terminal, the sensing switch is touched to control the power assembly through the controller to drive the lock tab assembly to unlock the lock beam. In this way, compared with the mode that needs to be operated in the mobile terminal in the related art, the present application can unlock the lock beam only by touching the sensing switch on the Bluetooth smart padlock, thereby avoiding the complex operation of unlocking the lock beam through the mobile terminal, to make the unlocking of the Bluetooth smart padlock simpler and more convenient.

### BRIEF DESCRIPTION OF THE DRAWINGS

In order to more clearly explain the embodiments of the present application or the technical solutions in the related art, the following will briefly introduce the drawings in the embodiments or the description of the related art. It is obvious that the drawings in the following description are only some embodiments of the present application. For those skilled in the art, other drawings can be obtained according to the structure shown in these drawings without paying creative labor.

FIG. 1 is a sectional view of a Bluetooth smart padlock according to an embodiment of the present application.

FIG. 2 is an explosion view of the Bluetooth smart padlock according to an embodiment.

FIG. 3 is a structural view of an embodiment of a first lock tab piece in the Bluetooth smart padlock of FIG. 2.

FIG. 4 is a structural view of an embodiment of a second lock tab piece in the Bluetooth smart padlock of FIG. 2.

FIG. 5 is a structural view of an embodiment of a lock tab mounting frame in the Bluetooth smart padlock in FIG. 2.

The realization of the purpose, functional features and advantages of the present application will be further described with reference to the attached drawings in combination with the embodiment.

### DETAILED DESCRIPTION OF THE EMBODIMENTS

The technical solution in the embodiment of the present application will be clearly and completely described below in combination with the attached drawings in the embodiment of the present application. Obviously, the described embodiments are only part of the embodiments of the present application, not all of the embodiments. Based on the embodiments in the present application, all other embodiments obtained by those skilled in the art without creative work belong to the claimed scope of the present application.

It should be noted that all directional indications (such as up, down, left, right, front, back . . . ) in the embodiment of the present application are only used to explain the relative position relationship and movement among components under a specific attitude (as shown in the attached drawings). If the specific attitude changes, the directional indication will change accordingly.

In addition, the description of “first”, “second” and the like in this application is only for descriptive purposes, and cannot be understood as indicating or implying its relative importance or implicitly indicating the number of indicated technical features. Thus, the features defined with “first” and “second” may include at least one of the features explicitly or implicitly. In addition, “and/or” in the full text includes three schemes, taking A and/or B as an example, it includes technical scheme A, technical scheme B, and both technical scheme A and B. In addition, the technical solutions of various embodiments can be combined with each other, but it must be based on the realization of those skilled in the art. When the combination of technical solutions is contradictory or impossible, it shall be considered that the combination of technical solutions does not exist and is not within the claimed scope of the present application.

Electronic padlock has gradually replaced the traditional padlock and becomes a mainstream product of small locks in the market because of its convenient use and wireless manipulation by mobile devices.

However, when unlocking the existing electronic padlock, it often needs to be close to the electronic padlock, the electronic padlock needs to be unlocked through the mobile phone after the mobile phone is connected with the Bluetooth of the electronic padlock. This unlocking method is cumbersome, which makes it inconvenient to unlock the electronic padlock.

In view of this, the present application proposes a Bluetooth smart padlock.

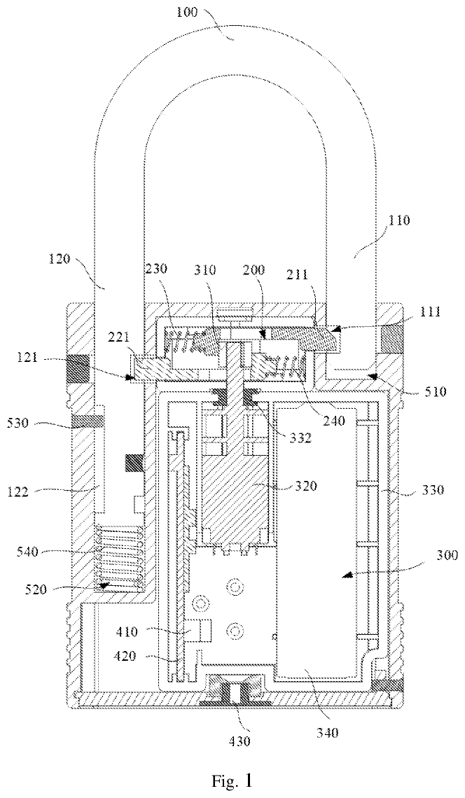

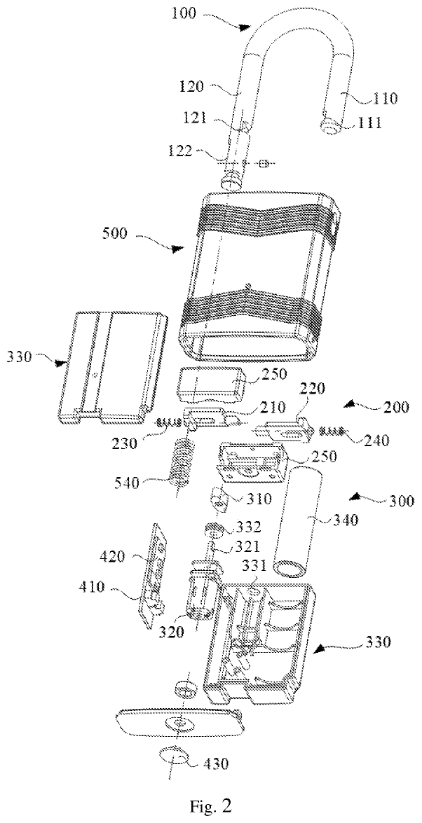

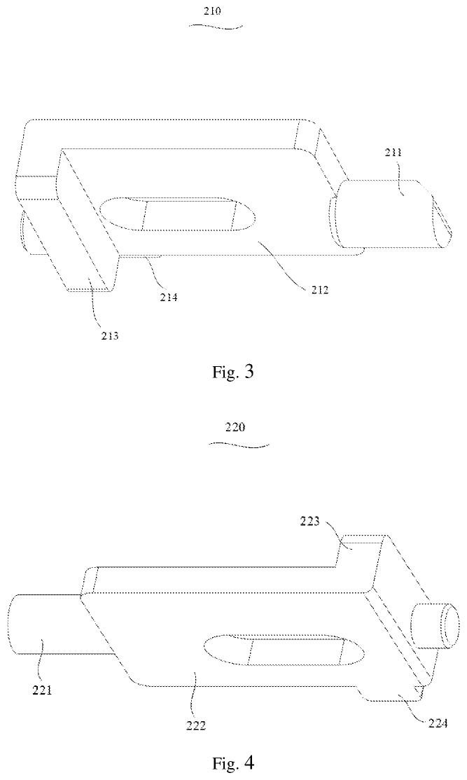

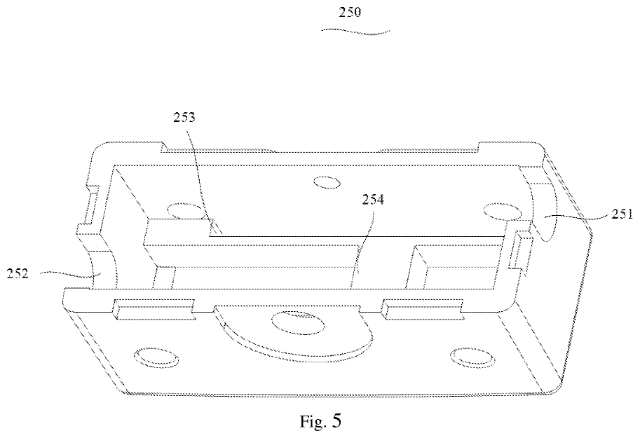

Referring to FIGS. 1 to 5, in the embodiment of the present application, the Bluetooth smart padlock includes a lock housing 500, a lock beam 100, a lock tab assembly 200, a power assembly 300 and a sensing switch 430. The lock housing 500 is provided with a Bluetooth module 410 and a controller 420. The Bluetooth module 410 is configured to establish a communication with the mobile terminal, and the controller 420 is electrically connected with the Bluetooth module 410. The lock beam 100 is partially provided in the lock housing 500, and the lock beam 100 is provided with a lock tab groove. The lock tab assembly 200 and the power assembly 300 are both provided in the lock housing 500. The lock tab assembly 200 includes a lock tab piece. The power assembly 300 is in transmission connection with the lock tab piece to drive the lock tab piece to extend into or separate from the lock tab groove, and thus unlock or lock the lock beam 100. The sensing switch 430 is provided in the lock housing 500 for controlling the power assembly 300 through the controller 420 to drive the lock tab assembly 200 to unlock the lock beam 100, after the Bluetooth module 410 establishes the communication with the mobile terminal.

Specifically, the Bluetooth module 410, the controller 420, part of the lock beam 100, the lock tab assembly 200, the power assembly 300 and the sensing switch 430 are all provided in the lock housing 500. The lock tab assembly 200 cooperates with the lock beam 100 to unlock or lock. When the power assembly 300 drives the lock tab piece to extend into the lock tab groove on the lock beam 100, the lock tab assembly 200 locks the lock beam 100. When the power assembly 300 drives the lock tab piece to separate from the lock tab groove on the locking beam 100, the lock tab assembly 200 unlocks the locking beam 100. In this embodiment, the controller 420 is electrically connected with the Bluetooth module 410, and the sensing switch 430 is electrically connected with the controller 420. The Bluetooth module 410 is configured to establish a communication with a mobile terminal, and the mobile terminal can be a mobile phone, a tablet or a computer.

When unlocking the lock beam 100, at first, the Bluetooth module 410 of the Bluetooth smart padlock is cooperated with the mobile terminal to establish a communication therebetween. After the Bluetooth module 410 establishes a communication with the mobile terminal, the controller 420 receives a signal indicating the establishment of the communication, and the controller 420 controls a conduction of a circuit between the power assembly 300 and the lock tab assembly 200. At this time, touching the sensing switch 430 to make the controller 420 start the power assembly 300, and the power assembly 300 drives the lock tab assembly 200 to move to separate from the lock tab groove and unlock the lock beam 100. In this way, the lock beam 100 can be unlocked by touching the sensing switch 430. Compared with the mode that needs to operate in the mobile terminal in the related art, the present application avoids the complex operation of the mobile terminal when the lock beam 100 is unlocked. The unlocking of the lock beam 100 can be realized only by touching the sensing switch 430 on the Bluetooth smart padlock, which makes the unlocking of the Bluetooth smart padlock simpler and convenient.

In a technical solution of the present application, the Bluetooth smart padlock is provided with a sensing switch 430. After the Bluetooth module 410 establishes a communication with the mobile terminal, the sensing switch 430 is touched to control the power assembly 300 through the controller 420 to drive the lock tab assembly 300 to unlock the lock beam 100. In this way, compared with the mode that needs to operate in the mobile terminal in the related art, the present application can unlock the lock beam 100 only by touching the sensing switch 430 on the Bluetooth smart padlock, thereby avoiding the complex operation of unlocking the lock beam through the mobile terminal, and making the unlocking of the Bluetooth smart padlock simpler and more convenient.

Further, the lock tab piece includes a first lock tab piece 210 and a second lock tab piece 220. One end of the lock tab beam 100 is extended to be a long lock tab beam 120 and another end of the lock tab beam 100 is extended to be a short lock tab beam 110. The short lock tab beam 110 is provided with a first lock tab groove 111, and the long lock tab beam 120 is provided with a second lock tab groove 121. The first lock tab piece 210 is extended into the first lock tab groove 111 and the second lock tab piece 220 is extended into the second lock tab groove 121, to make the lock tab assembly 200 to lock the lock tab beam 100. Specifically, the lock beam 100 is of a U-shaped structure, one end of which is extended to be the short lock beam 110 and another end of which is extended to be the long lock beam 120. A side of the short lock beam 110 facing the long lock beam 120 is provided with the first lock tab groove 111, and a side of the long lock beam 120 facing the short lock beam 110 is provided with the second lock tab groove 121. There are two lock tab pieces, namely the first lock tab piece 210 and the second lock tab piece 220. The first lock tab piece 210 is extended into the first lock tab groove 111 and the second lock tab piece 220 is extended into the second lock tab groove 121, to lock the first lock tab piece 210 and the second lock tab piece 220, that is, to lock the lock beam 100. In this way, the first lock tab piece 210 is provided at one end of the locking beam 100 and the second lock tab piece 220 is provided at another end of the locking beam 100 to lock both ends of the locking beam 100, so as to improve the reliability of locking the locking beam 100. At the same time, compared with a single side lock tab, the double side lock tabs of the present application can avoid the problem of not being locked caused by the excessive downward pulling of the Bluetooth smart padlock with only one single side lock tab, thereby ensuring that the Bluetooth smart padlock can be normally locked and the tensile strength of the Bluetooth smart padlock is improved.

Further, the first lock tab piece 210 is located above the second lock tab piece 220. Specifically, in the solution shown in the figures of the present application, the first lock tab piece 210 is located above the second lock tab piece 220, that is, the first lock tab piece 210 and the second lock tab piece 220 are not on the same height plane, and there is a height difference between the first lock tab piece 210 and the second lock tab piece 220. That is, there is also a height difference between the first lock tab groove 111 and the second lock tab groove 121. In this way, the first lock tab piece 210 can be locked at one end of the lock beam 100 and the second lock tab piece 220 can be locked at another end at different height of the lock beam 100, so as to improve the locking stability of the lock tab assembly 200 to the lock beam 100 and enhance the capability of resisting disassembling the Bluetooth smart padlock by force. Of course, the first lock tab piece 210 may be located below the second lock tab piece 220.

Further, the first lock tab piece 210 includes a first flat plate part 212, a first transmission part 213 connected to one end of the first flat plate part 212 and a first lock tab part 211 connected to another end of the first flat plate part 212. The second lock tab piece 220 includes a second flat plate part 222, a second transmission part 223 connected to one end of the second flat plate part 222 and a second lock tab part 221 connected to another end of the second flat plate part 222. The power assembly 300 includes a cam 310 located between the first flat plate part 212 and the second flat plate part 222. Two opposite sides of the cam 310 are abutted against the first transmission part 213 and the second transmission part 223 respectively, so that the cam 310 is in transmission connection with the first transmission part 213 and the second transmission part 223 to drive the first lock tab part 211 to extend into or separate from the first lock tab groove 111 and the second lock tab part 221 to extend into or separate from the second lock tab groove 121.

Specifically, the first lock tab piece 210 is of a irregular structure, and the first lock tab piece 210 includes the first lock tab part 211, the first flat plate part 212 and the first transmission part 213. The first lock tab part 211 is provided at one end of the first flat plate part 212 and is extendable along a length direction of the first flat plate part 212. In the solution shown in the figures of the present application, the first lock tab part 211 is of a cylindrical structure. Of course, the first lock tab part 211 can also be of a cuboid or another structural shape. The first transmission part 213 is provided at another end of the first flat plate part 212 and is extendable in a direction perpendicular to the first flat plate part 212, that is, the first flat plate part 212 and the first transmission part 213 form an “L” structure. The structure of the second lock tab piece 220 is the same with that of the first lock tab piece 210. Here, the second lock tab part 221, the second flat plate part 222 and the second transmission part 223 of the second lock tab piece 220 will not be described in detail. The power assembly 300 includes the cam 310 in transmission connection with the first lock tab piece 210 and the second lock tab piece 220. More specifically, the cam 310 is clamped between the first plate part 212 and the second plate part 222, and two opposite sides of the cam 310 are abutted against the first transmission part 213 and the second transmission part 223 respectively. In this way, when the cam 310 rotates, the cam 310 drives the first transmission part 213 and the second transmission part 223 to move towards each other, so as to drive the first lock tab part 211 to extend into or separate from the first lock tab groove 111 and the second lock tab part 221 to extend into or separate from the second lock tab groove 121, and lock or unlock the lock beam 100

Further, the first lock tab piece 210 is also provided with a first elastic piece 230 at one end of the first transmission part 213, the second lock tab piece 220 is also provided with a second elastic piece 240 at one end of the second transmission part 223, the first lock tab piece 210 and the second lock tab piece 220 are mounted in the lock tab mounting frame 250, and the lock tab mounting frame 250 is provided with a first opening 251 for the first lock tab part 211 to extend out and a second opening 252 for the second lock tab part 221 to extend out. The first elastic piece 230 is abutted against one end of the lock tab mounting frame 250 away from the first opening 251, and the second elastic piece 240 is abutted against one end of the lock tab mounting frame 250 away from the second opening 252.

Specifically, in order to improve the convenience of the first lock tab piece 210 extending into or separating from the first lock tab groove 111 and the second lock tab piece 220 extending into or separating from the second lock tab groove 121, a first elastic piece 230 cooperated with the first lock tab piece 210 and a second elastic piece 240 cooperated with the second lock tab piece 220 are provided. The first lock tab piece 210 and the second lock tab piece 220 are mounted in the lock tab mounting frame 250, an upper end of the lock tab mounting frame 250 is mounted with the first lock tab piece 210, and a lower end of the lock tab mounting frame 250 is mounted with the second lock tab piece 220. A side of the lock tab mounting frame 250 facing the short lock beam 110 is provided with the first opening 251 for the first lock tab part 211 to extend out, and a side of the lock tab mounting frame 250 facing the long lock beam 120 is provided with the second opening 252 for the second lock tab part 221 to extend out. The first elastic piece 230 is provided at one end of the first transmission part 213 and abutted against one end of the lock tab mounting frame 250 away from the first opening 251. The second elastic piece 240 is provided at one end of the second transmission part 223 and abutted against one end of the lock tab mounting frame 250 away from the second opening 252. In this way, through the setting of the first elastic piece 230 and the second elastic piece 240, when the cam 310 moves to a certain position, the first lock tab part 211 can be ejected under the elastic force of the first elastic piece 230 and the second lock tab part 221 can be ejected under the elastic force of the second elastic piece 240, and then the lock beam 100 is pressed downward along a height direction of the Bluetooth smart padlock to make the first lock tab part 211 to slide into the first lock tab groove 111 and the second lock tab part 221 to slide into the second lock tab groove 121, to lock the beam 100. In one embodiment, in order to facilitate the first lock tab part 211 to slide into the first lock tab groove 111 and the second lock tab part 221 to slide into the second lock tab groove 121, a slope structure is provided at one end of the first lock tab part 211 towards the first lock tab groove 111 and a slope structure is provided at one end of the second lock tab part 221 towards the second lock tab groove 121. In this way, the operation of the first lock tab part 211 sliding into the first lock tab groove 111 and the operation of the second lock tab part 221 sliding into the second lock tab groove 121 are simpler and more convenient. Of course, it may be only one of the first lock tab part 211 and the second lock tab part 221 provided with a slope structure.

Further, the first lock tab piece 210 also includes a first limit part 214, the second lock tab piece 220 also includes a second limit part 224, and the lock tab mounting frame 250 is provided with a first stop part 253 and a second stop part inside. After the first lock tab part 211 is separated from the first lock tab groove 111 and the second lock tab part 221 is separated from the second lock tab groove 121, the first limit part 214 is abutted against the first stop part 253, and the second limit part 224 is abutted against the second stop part.

Specifically, when the lock beam 100 is unlocked, the first lock tab piece 210 is separated from the first lock tab groove 111 and the second lock tab piece 220 is separated from the second lock tab groove 121. That is, both the first lock tab piece 210 and the second lock tab piece 220 move towards an inner side, and their movements towards the inner side have limit positions. In order to prevent the first lock tab piece 210 and the second lock tab piece 220 from moving too much towards the inner side, a limit structure is set at the limit position. More specifically, the first lock tab piece 210 is provided with a first limit part 214, and the lock tab mounting frame 250 is provided with a first stop part 253. When the first lock tab piece 210 is separated from the first lock tab groove 111 and moves towards the inner side to the limit position, the first limit part 214 is abutted against the first stop part 253, to stop the movement of the first lock tab piece 210 towards the inner side, that is, the first lock tab piece 210 is stopped from moving to separate from the first lock tab groove 111. In one embodiment, both the first limit part 214 and the first stop part 253 are bumps, and the specific structures of the first limit part 214 and the first stop part 253 are not limited here. The structures of the second limit part 224 and the second stop part are the same with those of the first limit part 214 and the first stop part 253 respectively, which will not be repeated here.

Further, a limit part 254 for the cam 310 is provided in the lock tab mounting frame 250. After the convex part of the cam 310 is abutted against the limit part 254 for the cam 310, the first lock tab part 211 is extended into the first lock tab groove 111 and the second lock tab part 221 is extended into the second lock tab groove 121. Specifically, in order to facilitate a switching between an unlocked state and a locked state of the lock beam 100, the cam 310 is provided with a limit structure of the cam 310. After the lock beam 100 is unlocked, the first lock tab part 211 and the second lock tab part 221 are located inside of the Bluetooth smart padlock. At this time, the cam 310 rotates according to the command. When the convex part of the cam 310 is abutted against the limit part 254 for the cam 310, the first lock tab part 211 is ejected under the elastic action of the first elastic piece 230 and the second lock tab part 221 is ejected under the elastic action of the second elastic piece 240, that is, the first lock tab part 211 is extended towards the first lock tab groove 111 and the second lock tab part 221 is extended towards the second lock tab groove 121.

Further, the power assembly 300 also includes a motor 320, a rotating shaft 321 of the motor 320 is in transmission connection with the cam 310. The motor 320 is mounted on the power mounting frame 330, and the power mounting frame 330 is provided with an exit port 331. The rotating shaft 321 is extended from the exit port 331, and a sealing ring 332 is clamped between the rotating shaft 321 and a wall of the exit port 331. Specifically, the Bluetooth smart padlock is provided with a power mounting frame 330 and the power mounting frame 330 is provided with electronic components such as the motor 320, a battery 340, the controller 420 and the Bluetooth module 410. In this way, the electronic components are all mounted in the power mounting frame 330, which facilitates the arrangement of electronic components. The power mounting frame 330 is provided with an exit port 331 for the rotating shaft 321 of the power supply machine 320 to extend out to be in transmission connection with the cam 310. A sealing ring 332 is provided at the exit port 331 and clamped between the rotating shaft 321 and the exit port 331 to block a gap therebetween, thus the power mounting frame 330 is a sealed structure, and the electronic components in the power mounting frame 330 are in a sealed space, thereby improving the waterproof performance of the Bluetooth smart padlock, making the whole of Bluetooth smart padlock to reach the IP68 rated of waterproof and dustproof, and improving the applicability of the Bluetooth smart padlock.

In the solution shown in the figures of the present application, the second flat plate part 222 is provided with a through hole, and the cam 310 is provided with a through hole. The rotating shaft 321 of the motor 320 successively passes through the through hole and the through hole to be in transmission connection with the cam 310. In order to ensure that the cam 310 has a certain motion stroke, the through hole has a certain size to meet the rotation needs of the cam 310. The first flat plate part 212 may or may not be provided with a through hole. When the first flat plate part 212 is also provided with a through hole, the structures of the first lock tab piece 210 and the second lock tab piece 220 are the same, which facilitates the processing of the lock tab assembly 200.

Further, the lock housing 500 is provided with a long lock beam groove 520 receiving the long lock beam 120 and a short lock beam groove 510 receiving the short lock beam 110. A bottom of the long lock beam groove 520 is provided with a lock beam spring 540, and the long lock beam 120 is located above the lock beam spring 540. Specifically, the lock housing 500 is provided with a long lock beam groove 520 and a short lock beam groove 510 to receive the long lock beam 120 and the short lock beam 110 respectively. A lock beam spring 540 is provided between the long lock beam 120 and the bottom of the long lock beam groove 520. When the lock tab assembly 200 is separated from the lock tab groove, the long lock beam 120 is moved upward under the elastic action of the lock beam spring 540, so that the lock beam 100 can be ejected from the lock housing 500, to unlock the lock beam 100. The setting of the lock beam spring 540 facilitates the ejection of the lock beam 100 from the lock housing 500 and the unlocking of the Bluetooth smart padlock.

Further, the long lock beam 120 is provided with a lock beam limit groove 122, and the lock housing 500 is provided with a lock beam limit bolt 530. At least part of the lock beam limit bolt 530 is located in the lock beam limit groove 122. Specifically, in order to prevent the lock beam 100 from falling out of the lock housing 500 after the lock beam 100 is unlocked, the lock beam limit groove 122 with a certain length is provided on the long lock beam 120, and correspondingly, the lock beam limit bolt 530 is provided on the lock housing 500. In this way, when the lock beam 100 is ejected from the lock housing 500, the lock beam limit bolt 530 is abutted against one end of the lock beam limit groove 122, to avoid the lock beam 100 to separate from the lock housing 500 and ensure the structural stability of the Bluetooth smart padlock.

The working principle of Bluetooth smart padlock is as follows:
Unlocking: firstly, the Bluetooth module 410 of the Bluetooth smart padlock is cooperated with the mobile terminal to establish a communication therebetween. After the Bluetooth module 410 establishes the communication with the mobile terminal, the controller 420 receives a signal indicating the establishment of the communication, and the controller 420 controls a conduction of the circuit between the power assembly 300 and the lock tab assembly 200. At this time, by touching the sensing switch 430, the controller 420 is controlled to start the power assembly 300. The motor 320 rotates, a rotating shaft 321 of the motor 320 drives the cam 310 to rotate, and the cam 310 drives the first transmission part 213 and the second transmission part 223 to move, so that the first lock tab piece 210 and the second lock tab piece 220 move towards each other. The first elastic piece 230 and the second elastic piece 240 are compressed until the first limit part 214 is abutted against the first stop part 253, and the second limit part 224 is abutted against the second stop part, and the first lock tab part 211 is separated from the first lock tab groove 111 and the second lock tab part 221 is separated from the second lock tab groove 121. At this time, one end of the long lock beam 120 is subjected to the elastic force of the lock beam spring 540, so that the long lock beam 120 is ejected from the long lock beam groove 520 and the short lock beam 110 is ejected from the short lock beam groove 510, to unlock the Bluetooth smart padlock.
Locking: about 2 min after the Bluetooth smart padlock is unlocked, the motor 320 automatically reverses, and the rotating shaft 321 of the motor 320 drives the cam 310 to reverse. After the convex part of the cam 310 is abutted against the limit part 254 of the cam 310, the first lock tab piece 210 is ejected under the action of the first elastic piece 230 and the second lock tab piece 220 is ejected under the action of the second elastic piece 240. That is, the first lock tab part 211 is ejected towards the short lock beam 110 and the second lock tab part 221 is ejected towards the long lock beam 120. At this time, the lock beam 100 is pressed downward to make the first lock tab part 211 to enter the first lock tab groove 111 and the second lock tab part 221 to enter the second lock tab groove 121, to lock the Bluetooth smart padlock.

The above is only an optional embodiment of the present application and does not limit the claimed scope of the present application. Any equivalent structural transformation made by using the contents of the description and drawings of the present application under the inventive concept of the present application, or any direct/indirect application in other relevant technical fields, are included in the claimed scope of the present application.

What is claimed is:

1. A Bluetooth smart padlock, comprising:
a lock housing provided with a Bluetooth module for establishing a communication with a mobile terminal and a controller electrically connected with the Bluetooth module;
a lock beam partially provided in the lock housing, and provided with a lock tab groove;
a lock tab assembly and a power assembly both provided in the lock housing, wherein the lock tab assembly comprises a lock tab piece, and the power assembly is in transmission connection with the lock tab piece to drive the lock tab piece to extend into or separate from the lock tab groove, to unlock or lock the lock beam; and
a sensing switch provided on the lock housing for controlling the power assembly through the controller to drive the lock tab assembly to unlock the lock beam after the communication between the Bluetooth module and the mobile terminal is established.

2. The Bluetooth smart padlock according to claim 1, wherein the lock tab piece comprises a first lock tab piece and a second lock tab piece, one end of the lock beam is extended to be a long lock beam and another end of the lock beam is extended to be a short lock beam;
wherein the short lock beam is provided with a first lock tab groove, and the long lock beam is provided with a second lock tab groove, the first lock tab piece is extended into the first lock tab groove and the second lock tab piece is extended into the second lock tab groove, to make the lock tab assembly lock the lock beam.

3. The Bluetooth smart padlock according to claim 2, wherein the first lock tab piece is located above the second lock tab piece.

4. The Bluetooth smart padlock according to claim 3, wherein,
the first lock tab piece comprises a first flat plate part, a first transmission part connected at one end of the first flat plate part and a first lock tab part connected at another end of the first flat plate part;
the second lock tab piece comprises a second flat plate part, a second transmission part connected at one end of the second flat plate part and a second lock tab part connected at another end of the second flat plate part; and
the power assembly comprises a cam located between the first flat plate part and the second flat plate part, and two opposite sides of the cam are abutted against the first transmission part and the second transmission part respectively, the cam is in transmission connection with the first transmission part and the second transmission part, to drive the first lock tab part to extend into or separate from the first lock tab groove and to drive the second lock tab part to extend into or separate from the second lock tab groove.

5. The Bluetooth smart padlock according to claim 4, wherein,
the first lock tab piece is further provided with a first elastic piece at one end of the first transmission part;
the second lock tab piece is further provided with a second elastic piece at one end of the second transmission part;
the first lock tab piece and the second lock tab piece are mounted in a lock tab mounting frame, and the lock tab mounting frame is provided with a first opening for the first lock tab piece to extend out and a second opening for the second lock tab part to extend out; and
the first elastic piece is abutted against one end of the lock tab mounting frame away from the first opening, and the second elastic piece is abutted against one end of the lock tab mounting frame away from the second opening.

6. The Bluetooth smart padlock according to claim 5, wherein,
the first lock tab piece further comprises a first limit part, and the second lock tab piece further comprises a second limit part; and
the lock tab mounting frame is provided with a first stop part and a second stop part;
after the first lock tab part is separated from the first lock tab groove and the second lock tab part is separated from the second lock tab groove, the first limit part is abutted against the first stop part, the second limit part is abutted against the second stop part.

7. The Bluetooth smart padlock according to claim 5, wherein a cam limit part is provided in the lock tab mounting frame, after a convex part of the cam is abutted against the cam limit part, the first lock tab part is extended into the first lock tab groove and the second lock tab part is extended into the second lock tab groove.

8. The Bluetooth smart padlock according to claim 7, wherein the power assembly further comprises a motor mounted on the power mounting frame, a rotating shaft of the motor is in transmission connection with the cam, the power mounting frame is provided with an exit port for the rotating shaft extending out, and a sealing ring is clamped between the rotating shaft and a wall of the exit port.

9. The Bluetooth smart padlock according to claim 2, wherein the lock housing is provided with a long lock beam groove receiving the long lock beam and a short lock beam groove receiving the short lock beam, a bottom of the long lock beam groove is provided with a lock beam spring, and the long lock beam is located above the lock beam spring.

10. The Bluetooth smart padlock according to claim 9, wherein the long lock beam is provided with a lock beam limit groove, the lock housing is provided with a lock beam limit bolt, and at least part of the lock beam limit bolt is located in the lock beam limit groove.
